(19) United States
(12) Patent Application Publication
(10) Pub. No.: US 2019/0252719 A1
(43) Pub. Date: Aug. 15, 2019

(54) METHOD FOR PRODUCING ALL SOLID-STATE BATTERY

(71) Applicant: Toyota Jidosha Kabushiki Kaisha, Toyota-shi Aichi-ken (JP)

(72) Inventor: Seiji Tomura, Susono-shi (JP)

(21) Appl. No.: 16/269,014

(22) Filed: Feb. 6, 2019

(30) Foreign Application Priority Data
Feb. 14, 2018 (JP) 2018-024460

(51) Int. Cl. H01M 10/0562; H01M 10/0525; H01M 4/36; H01M 4/139; H01M 4/40

(52) U.S. Cl. CPC H01M 10/0562; H01M 10/0525; H01M 2300/0068; H01M 4/139; H01M 4/405; H01M 4/366

(57) ABSTRACT

The thickness of a solid electrolyte layer is determined on the basis of the maximum particle diameter of a silicon-based anode active material and the surface roughness of an anode active material layer. Specifically, when an anode active material layer containing a silicon-based anode active material is formed on at least one surface of an anode current collector, and a solid electrolyte layer is formed on a surface of the anode active material layer which is on the opposite side of the anode current collector, the ratio (h/Dₘₐₓ) of the thickness (h) of the solid electrolyte layer to the maximum particle diameter (Dₘₐₓ) of the silicon-based anode active material is no less than 1.75, and the ratio (h/Rz) of the thickness (h) of the solid electrolyte layer to the surface roughness (Rz) of the anode active material layer before the solid electrolyte layer is formed is no less than 4.12.

### CROSS REFERENCE TO RELATED APPLICATIONS

The present application claims priority to Japanese Patent Application No. 2018-024460 filed on Feb. 14, 2018, the entire contents of which are hereby incorporated by reference.

### FIELD

The present application discloses a method for producing an all solid-state battery.

### BACKGROUND

As disclosed in Patent Literature 1 (JP 2013-069416 A), Patent Literature 2 (JP 2013-222530 A), and Patent Literature 3 (JP 2017-059534 A), a silicon-based anode active material can be used as an anode active material in an all solid-state lithium ion battery including a cathode, a solid electrolyte layer, and an anode. Such an all solid-state battery can be produced by laminating and pressing a first active material layer (such as an anode active material layer), a solid electrolyte layer and a second active material layer (such as a cathode active material layer) etc. as disclosed in, for example, Patent Literature 4 (JP 2017-130281 A).

### SUMMARY

### Technical Problem

According to new findings of this inventor, when an all solid-state battery is composed using a silicon-based anode active material, there is a case where the silicon-based anode active material breaks through a solid electrolyte layer due to expansion of the silicon-based anode active material or the like in charging to reach a cathode, which short-circuits the all solid-state battery.

### Solution to Problem

The present application discloses, as one means for solving the problem, a method for producing an all solid-state battery, the method comprising: a first step of forming an anode active material layer on at least one surface of an anode current collector; and a second step of forming a solid electrolyte layer on a surface of the anode active material layer, the surface being on an opposite side of the anode current collector, wherein the anode active material layer contains a silicon-based anode active material, a ratio (h/Dₘₐₓ) of a thickness (h) of the solid electrolyte layer to a maximum particle diameter (Dₘₐₓ) of the silicon-based anode active material is no less than 1.75, and a ratio (h/Rz) of the thickness (h) of the solid electrolyte layer to surface roughness (Rz) of the anode active material layer before the solid electrolyte layer is formed is, no less than 4.12.

In embodiments of this disclosure, the silicon-based anode active material is Si.

In embodiments of this disclosure, the solid electrolyte layer contains a sulfide solid electrolyte.

In embodiments of this disclosure, the ratio (h/Dₘₐₓ) is 1.75 to 2.50.

In embodiments of this disclosure, the ratio (h/Rz) is 4.12 to 6.67.

In embodiments of this disclosure, the thickness (h) of the solid electrolyte layer is 5 μm to 50 μm.

### Advantageous Effects

According to new findings of this inventor, when an all solid-state battery is charged, a silicon-based anode active material of a larger particle diameter expands more than that of a smaller particle diameter, and is easy to break through a solid electrolyte layer. That is, a solid electrolyte layer having a certain thickness or more (h), to the maximum particle diameter (Dₘₐₓ) of a silicon-based anode active material contained in an anode active material layer makes it possible for the silicon-based anode active material not to break through the solid electrolyte layer when the silicon-based anode active material expands.

According to new findings of this inventor, when the amount of a prominent (convex) silicon-based anode active material in the direction from an anode active material layer to a solid electrolyte layer on the interface between the anode active material layer and the solid electrolyte layer is large, the silicon-based anode active material greatly expands on this interface when an all solid-state battery is charged, to easily break through the solid electrolyte layer. The amount of a prominent silicon-based anode active material in the direction from an anode active material layer to a solid electrolyte layer on the interface between the anode active material layer and the solid electrolyte layer can be expressed by the surface roughness (Rz) of the anode active material layer on a solid electrolyte layer side. That is, a solid electrolyte layer having a certain thickness or more (h), to the surface roughness (Rz) of an anode active material layer on a solid electrolyte layer side makes it possible for a silicon-based anode active material not to break through the solid electrolyte layer when the silicon-based anode active material existing on the interface expands.

As described above, in the producing method of this disclosure, a solid electrolyte layer having a certain thickness or more (h), to the maximum particle diameter (Dₘₐₓ) of a silicon-based anode active material contained in an anode active material layer, and to the surface roughness (Rz) of the anode active material layer makes it possible for the silicon-based anode active material not to break through the solid electrolyte layer to reach a cathode, and for an all solid-state battery not to short-circuit even when the silicon-based anode active material expands or the like when the battery is charged.

### BRIEF DESCRIPTION OF DRAWINGS

FIG. 1 is a flowchart showing an example of a flow of a producing method of this disclosure;

FIGS. 2A and 2B are schematic views each showing an example of a flow of the producing method of this disclosure;

FIG. 3 is an explanatory schematic view of the maximum particle diameter (Dₘₐₓ) of a silicon-based anode active material and the thickness (h) of a solid electrolyte layer;

FIG. 4 is an explanatory schematic view of measurement of surface roughness of an anode active material layer; and

FIG. 5 is a schematic view showing an example of structure of an all solid-state battery produced by the producing method of this disclosure.

### DETAILED DESCRIPTION

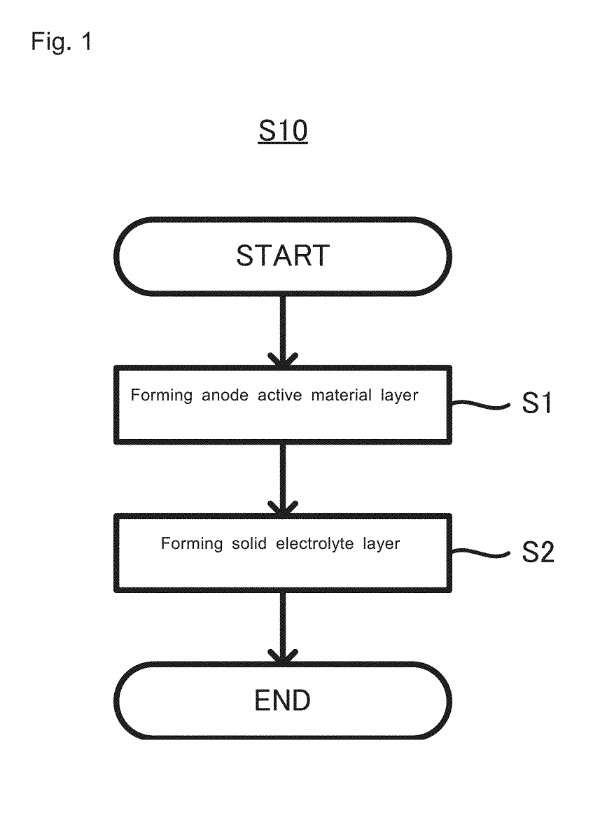

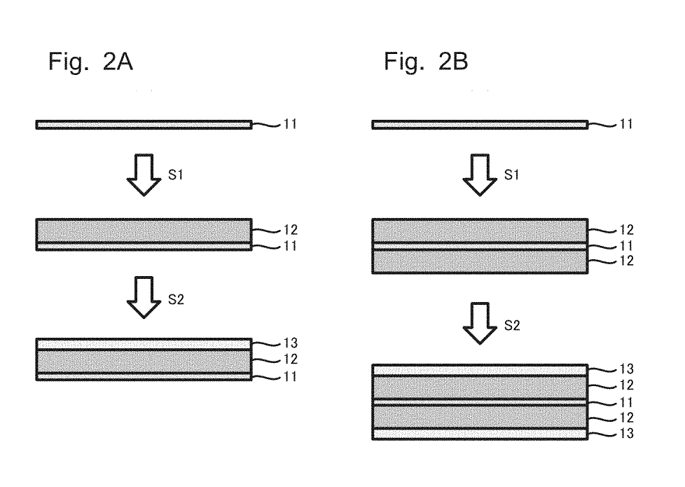

FIGS. 1 to 2B each show an example of a flow of a method for producing an all solid-state battery of this disclosure (producing method S10). As shown in FIGS. 1 to 2B, the producing method S10 includes a first step S1 of forming an anode active material layer 12 on at least one surface of an anode current collector 11; and a second step S2 of forming a solid electrolyte layer 13 on a surface of the anode active material layer 12, the surface being on an opposite side of the anode current collector 11. Here, in the producing method S10, the anode active material layer 12 contains a silicon-based anode active material. In addition, the ratio (h/Dₘₐₓ) of the thickness (h) of the solid electrolyte layer 13 to the maximum particle diameter (Dₘₐₓ) of the silicon-based anode active material is no less than 1.75. Further, the ratio (h/Rz) of the thickness (h) of the solid electrolyte layer 13 to the surface roughness (Rz) of the anode active material layer 12 before the solid electrolyte layer 13 is formed is no less than 4.12.

1. First Step S1

In the first step S1, the anode active material layer 12 is formed on at least one surface of the anode current collector 11. That is, as shown in FIG. 2A, the anode active material layer 12 may be formed on one surface of the anode current collector 11, or as shown in FIG. 2B, the anode active material layer 12 may be formed on either surface of the anode current collector 11. Hereinafter, the embodiment of forming the anode active material layer 12 on one surface of the anode current collector 11 will be described.

1.1. Anode Current Collector 11

The anode current collector 11 may be composed of metal foil, metal mesh, or the like. In some embodiments, the anode current collector 11 is composed of metal foil. Examples of metal constituting the anode current collector 11 include Cu, Ni, Fe, Ti, Co, Zn and stainless steel. The anode current collector 11 may be metal foil or a base material which is plated with the metal or on which the metal is deposited, as well. In some embodiments, the anode current collector 11 contains Cu. The anode current collector 11 may have some coating layer on its surface. The thickness of the anode current collector 11 is not specifically limited, and for example, is 0.1 μm to 1 mm in some embodiments, and 1 μm to 100 μm in some embodiments.

1.2. Anode Active Material Layer 12

The anode active material layer 12 at least contains the silicon-based anode active material as an anode active material. In some embodiments, the anode active material layer 12 contains a solid electrolyte, a binder, and a conductive additive.

1.2.1. Silicon-Based Anode Active Material

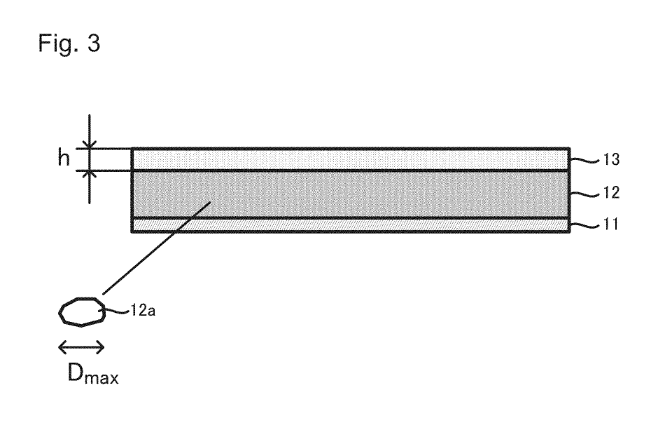

The silicon-based anode active material at least contains Si as a constituent element, and functions as an anode active material in the all solid-state battery. For example, at least one of Si, a Si alloy and a silicon oxide can be used. Some embodiments use Si. Some embodiments use a silicon oxide. The silicon-based anode active material may have an ordinary shape, that is, a particulate shape. The Silicon-based anode active material may be in the form of a primary particle or a secondary particle. The mean particle diameter (D₅₀) of the silicon-based anode active material is 0.01 μm to 10 μm in some embodiments. The lower limit thereof is no less than 0.05 μm in some embodiments, and no less than 0.1 μm in some embodiments. The upper limit thereof is no more than 5 μm in some embodiments, arid no more than 3 μm in some embodiments. The mean particle diameter (D₅₀) represents a median diameter(50% mean volume particle diameter) derived from particle size distribution measured resulting from a particle counter based on a laser scattering/diffraction method. As described later, in the producing method S10 of this disclosure, it is important for the solid electrolyte layer 13 to have a certain thickness or more (h), to the maximum particle diameter (Dₘₐₓ) of the silicon-based anode active material. “Maximum particle diameter (Dₘₐₓ) of the silicon-based anode active material” means the maximum particle diameter of a silicon-based anode active material having the largest maximum particle diameter (12a in FIG. 3) in all the silicon-based anode active materials contained in the anode active material layer 12. That is, one maximum particle diameter (Dₘₐₓ) is determined per anode active material layer. The maximum particle diameter (Dₘₐₓ) of the silicon-based anode active material contained in the anode active material layer 12 can be found using a particle counter based on a laser diffraction method. A specific value of the maximum particle diameter (Dₘₐₓ) of the silicon-based anode active material is not particularly limited, and for example, is 1 μm to 15 μm in some embodiments. The content of the silicon-based anode active material in the anode active material layer 12 is not specifically limited, and may be properly determined according to the performance of a battery to be aimed. For example, in some embodiments the content of the silicon-based anode active material is 30 mass % to 90 mass % if whole of the anode active material layer 12 is 100 mass %. In some embodiments, the lower limit thereof is no less than 50 mass %, and the upper limit thereof is no more than 80 mass %.

1.2.2. Other Constituents

The solid electrolyte at least functions as an electrolyte having lithium ion conductivity in the all solid-state battery. For example, in some embodiments the solid electrolyte is an inorganic solid electrolyte because ion conductivity is high compared with an organic polymer electrolyte. This is also because an inorganic solid electrolyte has a good heat resistance compared with an organic polymer electrolyte. This is moreover because an inorganic solid electrolyte is more brittle than an organic polymer electrolyte, and can be said to easily cause the problem as described above, which makes the effect of the producing method of the present disclosure more significant. Examples of an inorganic solid electrolyte include oxide solid electrolytes such as lithium lanthanum zirconate, LiPON, Li_{1+X}Al_{X}Ge_{2-X}(PO₄)₃, Li—SiO based glass, and Li—Al—S—O based glass; and sulfide solid electrolytes such as Li₂S—P₂S₅, Li₂S—SiS₂, LiI—Li₂S—SiS₂, LiI—Si₂S—P₂S₅, LiI—LiBr—Li₂S—P₂S₅, LiI—Li₂S—P₂S₅, LiI—Li₂S—P₂O₅, LiI—Li₃PO₄—P₂S₅, and Li₂S—P₂S₅—GeS₂. In some embodiments, the inorganic solid electrolyte is a sulfide solid electrolyte, such as a sulfide solid electrolyte containing Li₂S—P₂S₅. For example, the inorganic solid electrolyte is a sulfide solid electrolyte containing no less than 50 mol % of Li₂S—P₂S₅ in some embodiments. One solid electrolyte may be used individually, and two or more solid electrolytes may be mixed to be used. The solid electrolyte may have an ordinary shape, that is, a particulate shape. The particle diameter of the solid electrolyte is 0.01 μm to 5 μm in some embodiments. In some embodiments, the lower limit thereof is no less than 0.05 μm, or even no less than 0.1 μm. In some embodiments, the upper limit thereof is no more than 3 μm, or even no more than 2 μm. The content of the solid electrolyte in the anode active material layer 12 is not specifically limited, and may be properly determined according to the performance of a battery to be aimed. For example, in some embodiments the content of the solid electrolyte is 5 mass % to 60 mass % if whole of the anode active material layer 12 is 100 mass %. In some embodiments, the lower limit thereof is no less than 10 mass %, and the upper limit thereof is no more than 45 mass %.

Examples of the binder that may be contained in the anode active material layer 12 include butadiene rubber (BR), acrylate-butadiene rubber (ABR), styrene-butadiene rubber (SBR), polyvinylidene difluoride (PVdF), and polytetrafluoroethylene (PTFE). The content of the binder in the anode active material layer 12 may be the same as in a conventional one.

Examples of the conductive additive that may be contained in the anode active material layer 12 include carbon materials such as acetylene black, Ketjenblack, VGCF, and carbon nanofibers, and metallic materials such as nickel, aluminum, and stainless steel. The content of the conductive additive in the anode active material layer 12 may be the same as in a conventional one.

The anode active material layer 12 may contain an anode active material other than the silicon-based anode active material in addition to the silicon-based anode active material as long as the problem can be solved. Examples thereof include carbon materials such as graphite and hard carbon; various oxides such as lithium titanate; and various metals such as lithium metal and a lithium alloy. From the viewpoint that more significant effect can be exerted, the anode active material contained in the anode active material layer 12 includes no less than 90 mass %, no less than 95 mass %, or even no less than 99 mass % of a silicon-based active material in some embodiments. The anode active material contained in the anode active material layer 12 consists of a silicon-based active material in some embodiments.

1.3. Thickness of Anode Active Material Layer 12

According to findings of this inventor, the problem as described above is due to expansion of a silicon-based active material existing in the vicinity of the interface between the anode active material layer 12 and the solid electrolyte layer 13, and the thickness of the whole of the anode active material layer 12 hardly affects occurrence of the problem. That is, the anode active material layer 12 may have any thickness. However, in some embodiments the thickness of the anode active material layer 12 is determined so that the capacity of an anode is larger than that of a cathode. Specifically, the thickness of the anode active material layer 12 is 0.1 μm to 1 mm, or even μm to 100 μm in some embodiments.

1.4. Surface Roughness of Anode Active Material Layer 12

As described later, in the producing method S10 of this disclosure, it is important for the solid electrolyte layer 13 to have a certain thickness or more (h), to the surface roughness (Rz) of the anode active material layer 12. Here, a specific value of the surface roughness (Rz) of the anode active material layer 12 is not particularly limited, and in some embodiments Rz is as low as possible in order to thin the solid electrolyte layer 13. For example, Rz is no more than 7 μm, or even no more than 4.5 μm in some embodiments.

1.5. Method for Forming Anode Active Material Layer 12

In the first step S1, a method of forming the anode active material layer 12 on at least one surface of the anode current collector 11 is not specifically restricted. For example, the anode active material layer 12 can be formed on at least one surface of the anode current collector 11 by dispersing and/or dissolving the above described constituents of the anode active material layer 12 in solvent to make slurry, and coating at least one surface of the anode current collector 11 with the slurry to dry and optionally press the surface with the slurry. Adjusting the amount of coating of the slurry etc. makes it possible to easily adjust the thickness of the anode active material layer 12. Adjusting the viscosity of the slurry makes it possible to adjust the surface roughness (Rz) of the anode active material layer 12 which will be described later. According to findings of this inventor, a higher viscosity leads to higher Rz, and a lower viscosity leads to lower Rz. The viscosity of an anode slurry can be easily adjusted by changing the solid content, adding a thickener, and so on. The anode active material layer 12 may be formed by press forming powder of the anode active material etc. on a surface of the anode current collector 11 in a dry process instead of wet forming as described above. From the viewpoint that a strong anode active material layer 12 can be industrially stably formed on a surface of the anode current collector 11, the anode active material layer 12 is formed on a surface of the anode current collector 11 by wet forming using solvent in some embodiments.

2. Second Step S2

In the second step S2, the solid electrolyte layer 13 is formed on a surface of the anode active material layer 12 which is on the opposite side of the anode current collector 11.

2.1. Solid Electrolyte Layer 13

The solid electrolyte layer 13 has functions of isolating the anode from the cathode, and conducting lithium ions between the anode and the cathode. The solid electrolyte layer 13 at least contains a solid electrolyte. The solid electrolyte layer 13 contains a binder in some embodiments.

2.1.1. Solid Electrolyte

The solid electrolyte contained in the solid electrolyte layer 13 may be properly selected from the examples of the solid electrolyte that may be contained in the anode active material layer 12. In some embodiments, the solid electrolyte is a sulfide solid electrolyte, such as a sulfide solid electrolyte containing Li₂S—P₂S₅. For example, in some embodiments the solid electrolyte is a sulfide solid electrolyte containing no less than 50 mol % of Li₂S—P₂S₅. One solid electrolyte may be used individually, and two or more solid electrolytes may be mixed to be used. The solid electrolyte may have an ordinary shape, that is, a particulate shape. Details thereof are as described above. The content of the solid electrolyte in the solid electrolyte layer 13 is not specifically limited, and may be properly determined according to the performance of a battery to be aimed. For example, in some embodiments the content of the solid electrolyte is no less than 90 mass %, or even no less than 95 mass %, if whole of the solid electrolyte layer 13 is 100 mass %.

2.1.2. Binder

In some embodiments, the solid electrolyte layer 13 contains a binder. The binder that may be contained in the solid electrolyte layer 13 is publicly known. For example, the binder may be properly selected from the examples of the binder that may be contained in the anode active material layer 12.

2.2. Thickness of Solid Electrolyte Layer 13

The thickness (h) of the solid electrolyte layer 13 is determined according to the maximum particle diameter (Dₘₐₓ) of the silicon-based anode active material contained in the anode active material layer 12 and the surface roughness (Rz) of the anode active material layer 12 as described later. Specifically, such a problem that the silicon-based anode active material expands to break through the solid electrolyte layer as described above tends to arise when the solid electrolyte layer 13 is thin. That is, in view of more significant effect of the producing method of this disclosure, the thickness of the solid electrolyte layer 13 is thin in some embodiments, and for example 0.1 μm to 100 μm. In some embodiments, the lower limit thereof is no less than 5 μm, and the upper limit thereof is no more than 50 μm. Thinning the solid electrolyte layer 13 can improve ion conductivity between the cathode and the anode, and also can improve energy density of the battery.

2.3. Method for Forming Solid Electrolyte Layer 13

In the second step S2, a method of forming the solid electrolyte layer 13 on the surface of the anode active material layer 12 is not specifically restricted. For example, the solid electrolyte layer 13 can be formed on the surface of the anode active material layer 12 by dispersing or dissolving the above described constituents of the solid electrolyte layer 13 in solvent to make slurry, and coating the surface of the anode active material layer 12 with the slurry to dry and optionally press the surface with the slurry. Adjusting the amount of coating of the slurry etc. makes it possible to easily adjust the thickness of the solid electrolyte layer 13. The solid electrolyte layer 13 may be formed by press forming the solid electrolyte etc. on the surface of the anode active material layer 12 in a dry process instead of wet forming as described above. Alternatively, the solid electrolyte layer 13 may be formed on another base material, to be transferred on the surface of the anode active material layer 12. Or, the solid electrolyte layer 13 may be formed on a cathode side which will be described later, to be bonded to the surface of the anode active material layer 12. From the viewpoint that a strong solid electrolyte layer 13 can be industrially stably formed on the surface of the anode active material layer 12, the solid electrolyte layer 13 is formed on the surface of the anode active material layer 12 by wet forming using solvent in some embodiments.

3. Relationship Between Maximum Particle Diameter of Silicon-Based Anode Active Material and Thickness of Solid Electrolyte Layer 13

As shown in FIG. 3, in the producing method S10 of this disclosure, it is important that the ratio (h/Dₘₐₓ) of the thickness (h) of the solid electrolyte layer 13 to the maximum particle diameter (Dₘₐₓ) of the silicon-based anode active material (the maximum particle diameter of the silicon-based anode active material 12a having the largest particle diameter) is no less than 1.75. For example, one may measure the maximum particle diameter (Dₘₐₓ) of the silicon-based anode active material used in the first step S1 in advance, and adjust the amount of coating of an electrolyte slurry etc. so that the thickness (h) of the solid electrolyte layer 13 to the maximum particle diameter thereof (Dₘₐₓ) is no less than 1.75. According to new findings of this inventor, the ratio thereof (h/Dₘₐₓ) of no less than 1.75 makes it possible for the silicon-based anode active material not to break through the solid electrolyte layer even when the silicon-based anode active material expands in charging. The upper limit of the ratio (h/Dₘₐₓ) is not specifically restricted. As described above, in view of more significant effect of the producing method of this disclosure, and of the ion conductivity and energy density, the thickness (h) of the solid electrolyte layer 13 is as thin as possible in some embodiments. In this point, the ratio (h/Dₘₐₓ) is 1.75 to 2.50 in some embodiments.

It seems that using a silicon-based active material having small Dₘₐₓ also makes it possible to have the ratio (h/Dₘₐₓ) of no less than 1.75. However, according to new findings of this inventor, there is a case where the surface roughness Rz of the anode active material layer 12 becomes high even when Dₘₐₓ of a silicon-based active material is small. In this case, the silicon-based anode active material may expand in charging to break through the solid electrolyte layer on the interface between the anode active material layer 12 and the solid electrolyte layer 13. That is, just using a silicon-based active material having small Dₘₐₓ inadequate for solving the problem.

4. Relationship Between Surface Roughness of Anode Active Material Layer 12 and Thickness of Solid Electrolyte Layer 13

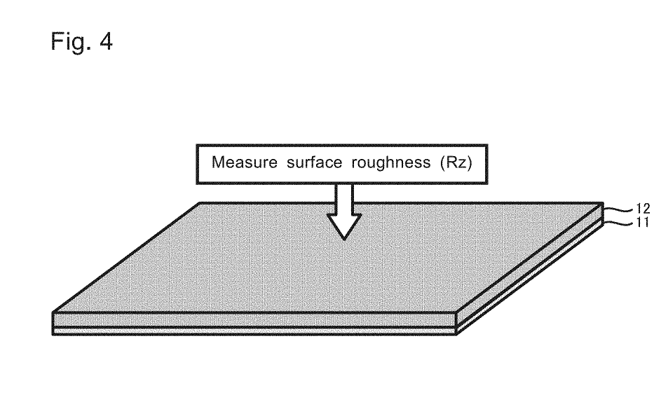

In the producing method S10 of this disclosure, it is important that the ratio (h/Rz) of the thickness (h) of the solid electrolyte layer 13 to the surface roughness (Rz) of the anode active material layer 12 before the solid electrolyte layer 13 is formed (that is, the surface roughness (Rz) of the surface of the anode active material layer 12 where the solid electrolyte layer 13 is to be formed in the second step S2) is no less than 4.12. “Surface roughness (Rz)” corresponds to the maximum height roughness of a surface. As shown in FIG. 4, the surface roughness (Rz) of the anode active material layer 12 before the solid electrolyte layer 13 is formed can be found by, for example, measuring “line roughness” of the surface of the anode active material layer 12 which is on the opposite side of the anode current collector 11, on a laminate of the anode current collector 11 and the anode active material layer 12 which is obtained in the first step S1, using a laser microscope, conforming to JIS B0601: 1994. After the surface roughness (Rz) of the anode active material layer 12 is measured as described above, the amount of coating of an electrolyte slurry etc. may be adjusted so that the thickness (h) of the solid electrolyte layer 13 to the surface roughness thereof (Rz) is no less than 4.12. According to new findings of this inventor, the ratio (h/Rz) of no less than 4.12 makes it possible for the silicon-based anode active material not to break through the solid electrolyte layer even when the silicon-based anode active material existing on the interface between the anode active material layer 12 and the solid electrolyte layer 13 expands in charging. The upper limit of the ratio (h/Rz) is not specifically restricted. As described above, in view of more significant effect of the producing method of this disclosure, and of the ion conductivity and energy density, the thickness (h) of the solid electrolyte layer 13 is as thin as possible in some embodiments. In this point, the ratio (h/Rz) is 4.12 to 6.67 in some embodiments.

It seems that mechanically processing (pressing or the like) the surface of the anode active material layer 12 also makes it possible for the anode active material layer 12 to have low surface roughness Rz. However, according to new findings of this inventor, there is a case where the silicon-based anode active material expands in charging to break through the solid electrolyte layer if a coarse silicon-based anode active material particle exists in the anode active material layer 12 even when the surface roughness Rz of the anode active material layer 12 is low. That is, just having low surface roughness Rz of the anode active material layer 12 is inadequate for solving the problem. The problem can be properly solved by satisfying the requirement of the ratio (h/Dₘₐₓ) and the requirement of the ratio (h/Rz) at the same time as in the producing method of this disclosure.

5. Other Constituents

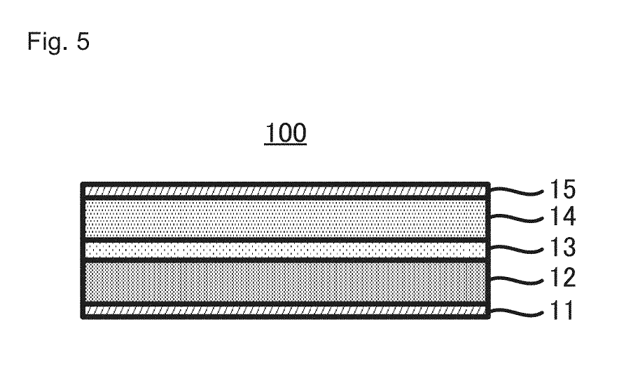

As shown in FIG. 5, an all solid-state battery 100 usually includes a cathode active material layer 14 and a cathode current collector 15 in addition to the anode current collector 11, the anode active material layer 12 and the solid electrolyte layer 13. In FIG. 5, terminals, a battery case, etc. are omitted. In the producing method S10 of this disclosure, for example, after the second step S2, the cathode active material layer 14 and the cathode current collector 15 are formed over a surface of the solid electrolyte layer 13 which is on the opposite side of the anode active material layer 12, which makes it possible to produce the all solid-state battery 100. The structure of the cathode in the all solid-state battery 100 is obvious, and hereinafter one example thereof will be described.

The cathode active material layer 14 at least contains a cathode active material. In some embodiments, the cathode active material layer 14 contains a solid electrolyte, a binder, and a conductive additive.

Any known one as a cathode active material of an all solid-state battery can be employed for the cathode active material. Among known active materials, a material showing a nobler charge/discharge potential than a silicon-based active material as described above may be the cathode active material. For example, a lithium containing oxide such as lithium cobaltate, lithium nickelate, Li(Ni,Mn,Co)O₂(Li_{1+α}Ni_{1/3}Mn_{1/3}CO_{1/3}O₂), lithium manganate, spinel lithium composite oxides, lithium titanate, and lithium metal phosphates (LiMPO₄ where M is at least one selected from Fe, Mn, Co and Ni) can be used as the cathode active material. One cathode active material may be used alone, and two or more cathode active materials may be mixed to be used. The cathode active material may have a coating layer of lithium niobate, lithium titanate, lithium phosphate, or the like over the surface thereof. The shape of the cathode active material is not specifically limited, and is, for example, in the form of a particle or a thin film. The content of the cathode active material in the cathode active material layer 14 is not specifically limited, and may be equivalent to the amount of a cathode active material contained in a cathode active material layer of a conventional all solid-state battery. Any known one as a solid electrolyte for an all solid-state battery can be employed as the solid electrolyte. For example, a sulfide solid electrolyte as described above is employed in some embodiments. An inorganic solid electrolyte other than a sulfide solid electrolyte may be contained in addition to a sulfide solid electrolyte as long as a desired effect can be brought about. The conductive additive and the binder can be properly selected from ones described concerning the anode active material layer 12, to be employed as well. One solid electrolyte (conductive additive, binder) may be used alone, and two or more solid electrolytes (conductive additives, binders) may be mixed to be used. The shapes of the solid electrolyte and the conductive additive are not specifically limited, and for example, are in the form of a particle in some embodiments. The contents of the solid electrolyte, the conductive additive, and the binder in the cathode mixture layer are not specifically limited, and may be equivalent to the amounts of a solid electrolyte, a conductive additive, and a binder contained in a cathode active material layer of a conventional all solid-state battery.

In some embodiments, the thickness of the cathode active material layer is, for example, 0.1 μm to 1 mm, or even 1 μm to 100 μm.

The cathode current collector 15 may be composed of metal foil, metal mesh, or the like. In some embodiments, the cathode current collector 15 is composed of metal foil. Examples of metal that may constitute the cathode current collector 15 include stainless steel, nickel, chromium, gold, platinum, aluminum, iron, titanium, and zinc. The cathode current collector 15 may be metal foil or a base material which is plated with the metal or on which the metal is deposited, as well.

The cathode active material layer 14 having the above described structure can be easily formed via a process such as kneading the cathode active material, and the solid electrolyte, binder and conductive additive, which are optionally contained, in solvent to obtain a slurry, and thereafter applying this slurry onto the surface of the solid electrolyte layer 13 (surface on the opposite side of the anode active material layer 12) and drying the layer. In this case, the all solid-state battery 100 can be produced via a process such as laminating the cathode current collector 15 on a surface of the cathode active material layer 14 after the cathode active material layer 14 is formed, to press them. Or, the all solid-state battery 100 can be also produced via a process such as forming the cathode active material layer 14 on a surface of the cathode current collector 15 via a process such as applying slurry containing the cathode active material etc. onto the surface of the cathode current collector 15 to dry the surface with the slurry, thereafter overlaying the solid electrolyte layer 13 and the cathode active material layer 14 with each other to press them. The cathode active material layer 14 can be produced by not only such a wet process but also a dry process.

Since the volume of expansion/contraction of a cathode active material in charging and discharging is generally smaller than that of a silicon-based anode active material, there is a low possibility that the cathode active material expands when the battery is charged and discharged, to break through the solid electrolyte layer 13. However, in view of further suppressing expansion of the cathode active material to break through the solid electrolyte layer 13, the technique of this disclosure is applied to the cathode as well in some embodiments. That is, in some embodiments the ratio (h/Dₘₐₓ) of the thickness (h) of the solid electrolyte layer 13 to the maximum particle size (Dₘₐₓ) of the cathode active material contained in the cathode active material layer 14 is no less than 1.75, and the ratio (h/Rz) of the thickness (h) of the solid electrolyte layer to the surface roughness (Rz) of the cathode active material layer 14 is no less than 4.12.

6. Addition (Difference from Battery of Electrolyte Solution System)

The problem tends to arise in an all solid-state battery using a solid electrolyte layer. That is, a solid electrolyte layer is an aggregate of a solid electrolyte particle (and a binder) as described above, and has low resistance to prominence, and a silicon-based anode active material is easy to break through a solid electrolyte layer when expanding. In contrast, a separator in the form of a film is usually used between a cathode and an anode in a battery of the electrolyte solution system. Since this separator has flexibility etc., and higher resistance to prominence than the solid electrolyte layer, the problem seldom arises. That is, the technique of this disclosure can be said to dissolve the problem unique to an all solid-state battery.

### EXAMPLES

1. Forming Anode Active Material Layer

A sulfide solid electrolyte (Li2S—P2S5), a binder (KFW manufactured by Kureha Corporation), and a conductive additive (VGCF manufactured by Showa Denko K.K.) were dispersed and kneaded in butyl butyrate, and thereafter a silicon-based anode active material (Si manufactured by Elkem ASA) was added to be further kneaded, to obtain an anode slurry. The anode slurry was such that 80 parts by mass of the sulfide solid electrolyte, 5 parts by mass of the binder, and 5 parts by mass of the conductive additive were contained, to 100 parts by mass of the silicon-based anode active material. A surface of an anode current collector (copper foil having approximately 14 μm in thickness) was coated with the obtained anode slurry by means of a doctor blade to be dried and pressed, to form an anode active material layer (50 μm in thickness) on the surface of the anode current collector. Here, the surface roughness (Rz) of the anode active material layer shall be changed by adjusting the viscosity of the slurry by the solvent ratio. It is noted that the particle size distribution of the silicon-based anode active material was measured by means of a particle counter based on a laser diffraction method (Microtrac MT3300EX2), to find the maximum particle diameter (Dₘₐₓ) of the silicon-based anode active material contained in the anode active material layer in advance.

2. Measurement of Surface Roughness of Anode Active Material Layer

The surface roughness (Rz) of a surface of the obtained anode active material layer (surface where a solid electrolyte layer was to be formed) was measured. Specifically, as shown in FIG. 4, “line roughness” of the surface of the anode active material layer which is on the opposite side of the anode current collector was measured on a laminate of the anode current collector and the anode active material layer, using a laser microscope (VK-X200 manufactured by Keyence Corporation), conforming to JIS B0601: 1994, which was used as the surface roughness (Rz).

3. Forming Solid Electrolyte Layer

The sulfide solid electrolyte layer, and a binder (acrylate-butadiene rubber, ABR manufactured by JSR Corporation) were weighed so as to have the mass ratio of 99:1, put into heptane, and thereafter dispersed by means of an ultrasonic homogenizer, to obtain an electrolyte slurry. The surface of the anode active material layer was coated with the obtained electrolyte slurry to be dried and pressed, to form the solid electrolyte layer on the surface of the anode active material layer. Here, the thickness (h) of the solid electrolyte layer shall be changed by changing the coating amount of the electrolyte slurry. The thickness (h) of the solid electrolyte layer was actually measured by observing a cross-section of the solid electrolyte layer.

3. Laminating Cathode

A cathode active material layer and a cathode current collector were laminated over a surface of the solid electrolyte layer by a method as disclosed in Patent Literature 4. Specifically, a cathode active material (Li(Ni,Co,Mn)Oₓ), a sulfide solid electrolyte, a binder (KFW manufactured by Kureha Corporation), and a conductive additive (VGCF manufactured by Showa Denko K.K.) were weighed so as to have the mass ratio of 100:30:5:5, dispersed and kneaded in butyl butyrate, to obtain a cathode slurry. The surface of the solid electrolyte layer was coated with the obtained cathode slurry to be dried and pressed, to form the cathode active material layer (50 μm in thickness) on the surface of the solid electrolyte layer. Thereafter, the cathode current collector (Al foil) was laminated onto a surface of the cathode active material layer to be hot-pressed, to obtain an all solid-state battery having structure as shown in FIG. 5.

4. Confirmation of Presence or Not of Short Circuits in All Solid-State Battery

The presence or not of short circuits in the made all solid-state battery was confirmed in view of the following three points.

(1) The presence or not of short circuits was confirmed by OCV of the all solid-state battery.

(2) The presence or not of unusualness in CV-CC charging of the all solid-state battery was confirmed. When unusualness such as not rising to a predetermined voltage, and a larger charge capacity than the original battery capacity was confirmed, the all solid-state battery was determined to short-circuit.

(3) The discharge capacity of the all solid-state battery was confirmed. When unusual discharge capacity was confirmed, the all solid-state battery was determined to short-circuit.

As shown in the following Table 1, a plurality of the all solid-state batteries for each of which the thickness (h) of the solid electrolyte layer, the maximum particle diameter (Dₘₐₓ) of the silicon-based anode active material contained in the anode active material layer, and the surface roughness (Rz) of the anode active material layer were changed were made, and the presence or not of short circuits was confirmed in each battery. The results are shown in Table 1.

TABLE 1

| | | Maximum | | | | |
|---|---|---|---|---|---|---|
| | | particle | | | | |
| | | diameter | Surface | | | |
| | | of | roughness | | | Pres- |
| | Thickness | anode | of anode | | | ence |
| | of solid | active | active | | | or not |
| | electrolyte | material | material | | | of |
| | layer | Dmax | layer | | | short |
| | h (μm) | (μm) | Rz (μm) | h/Dmax | h/Rz | circuits |
| Ex. 1 | 14 | 8 | 3.4 | 1.75 | 4.12 | None |
| Ex. 2 | 22 | 12 | 4.5 | 1.83 | 4.89 | None |
| Ex. 3 | 14 | 7.3 | 3.1 | 1.92 | 4.52 | None |
| Ex. 4 | 30 | 12 | 4.5 | 2.50 | 6.67 | None |
| Comp. Ex. 1 | 14 | 26 | 15.9 | 0.54 | 0.88 | Present |
| Comp. Ex. 2 | 22 | 26 | 15.9 | 0.85 | 1.38 | Present |
| Comp. Ex. 3 | 14 | 12 | 4.5 | 1.17 | 3.11 | Present |
| Comp. Ex. 4 | 14 | 10 | 3.5 | 1.40 | 4.00 | Present |
| Comp. Ex. 5 | 14 | 7.3 | 6.1 | 1.92 | 2.30 | Present |

As apparent from the results shown in Table 1, when the ratio (h/Dₘₐₓ) was no less than 1.75 and the ratio (h/Rz) was no less than 4.12 (Examples 1 to 4), it was possible to prevent the all solid-state battery from short-circuiting. It is believed that even if the silicon-based active material expanded in charging, it was possible to properly prevent breaking through the solid electrolyte layer. As apparent from the result of Comparative Example 5, there was a case where the ratio (h/Rz) did not become high even if the silicon-based anode active material had a small maximum particle diameter Dₘₐₓ and the ratio (h/Dₘₐₓ) was no less than a predetermined ratio. In this case, it was impossible to prevent the all solid-state battery from short-cincturing. It is important that the ratio (h/Dₘₐₓ) was no less than 1.75 and the ratio (h/Rz) was no less than 4.12 as Examples 1 to 4.

### INDUSTRIAL APPLICABILITY

An all solid-state battery produced by the producing method according to this disclosure can be used in a wide range of power sources including a small-sized power source for portable devices etc., and an onboard large-sized power source.

What is claimed is:

1. A method for producing an all solid-state battery, the method comprising:
a first step of forming an anode active material layer on at least one surface of an anode current collector; and
a second step of forming a solid electrolyte layer on a surface of the anode active material layer, the surface being on an opposite side of the anode current collector, wherein
the anode active material layer contains a silicon-based anode active material, a ratio (h/Dₘₐₓ) of a thickness (h) of the solid electrolyte layer to a maximum particle diameter (Dₘₐₓ) of the silicon-based anode active material is no less than 1.75, and
a ratio (h/Rz) of the thickness (h) of the solid electrolyte layer to surface roughness (Rz) of the anode active material layer before the solid electrolyte layer is formed is no less than 4.12.

2. The method according to claim 1, wherein the silicon-based anode active material is Si.

3. The method according to claim 1, wherein the solid electrolyte layer contains a sulfide solid electrolyte.

4. The method according to claim 1, wherein the ratio (h/Dₘₐₓ) is 1.75 to 2.50.

5. The method according to claim 1, wherein the ratio (h/Rz) is 4.12 to 6.67.

6. The method according to claim 1, wherein the thickness (h) of the solid electrolyte layer is 5 μm to 50 μm.
